(19) United States
(12) Patent Application Publication
(10) Pub. No.: US 2023/0097326 A1
(43) Pub. Date: Mar. 30, 2023

(54) POLYMER LAYER AND DISPLAY DEVICE INCLUDING THE SAME

(71) Applicants: SAMSUNG DISPLAY CO., LTD., Yongin-si (KR); SEOUL NATIONAL UNIVERSITY R&DB FOUNDATION, Seoul (KR)

(72) Inventors: WOONG-RYEOL YU, Seoul (KR); Heonjung Shin, Hwaseong-si (KR); Yeonsong Kim, Incheon (KR); Jinsu Kim, Goyang-si (KR); Hyun Joon Oh, Seongnam-si (KR); Jeoungsub Lee, Seoul (KR); Sangho Hwang, Suwon-si (KR)

(21) Appl. No.: 17/662,464

(22) Filed: May 9, 2022

(30) Foreign Application Priority Data
Sep. 15, 2021 (KR) 10-2021-0123072

(51) Int. Cl. C08L 85/04; B32B 27/28; B32B 7/12; B32B 27/20; B32B 27/08

(52) U.S. Cl. CPC C08L 85/04; B32B 27/283; B32B 7/12; B32B 27/20; B32B 27/08; B32B 2457/20; B32B 2307/542

(57) ABSTRACT

A polymer layer includes a composition including polyborondimethylsiloxane and benzoyl peroxide. The polymer layer has a light transmittance of about 84% or more in a wavelength range of about 400 nm to about 800 nm. Therefore, the polymer layer exhibits strong impact resistance and optical transparency.

### CROSS-REFERENCE TO RELATED APPLICATIONS

This U.S. non-provisional patent application claims priority under 35 U.S.C. § 119 of Korean Patent Application No. 10-2021-0123072, filed on Sep. 15, 2021, the entire contents of which are hereby incorporated by reference.

### TECHNICAL FIELD

The present disclosure relates to a polymer layer and a display device including the polymer layer.

### DISCUSSION OF THE RELATED ART

Display devices provide a user with information by displaying various images on a display screen. Recently, flexible display devices, which are capable of being folded, rolled, stretched, or bent, have been developed. Flexible display devices may allow for electronic devices to be made having a wide variety of new and interesting form factors.

Unlike rigid display devices, that may make use of a thick protective glass window, flexible display devices may be vulnerable to external damage. A protective film may be disposed on an uppermost portion of a flexible display device to provide some level of impact resistance.

### SUMMARY

A polymer layer is derived from a composition including polyborondimethylsiloxane and benzoyl peroxide. The polymer layer has a light transmittance of about 84% or more in a wavelength range of about 400 nm to about 800 nm.

The polymer layer may have shear thickening properties so that a storage modulus may increase when external force is applied.

The polyborondimethylsiloxane may include a repeating unit represented by Formula 1 below.

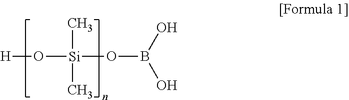

In Formula 1, n is a positive integer.

A mass ratio of the polyborondimethylsiloxane to the benzoyl peroxide may be about 8:1 to about 53:1.

The polyborondimethylsiloxane may be formed through a condensation polymerization reaction between polydimethylsiloxane and boric acid and the mass ratio of the polydimethylsiloxane to the boric acid may be about 25:1 to about 500:1.

The polymer layer may be formed by carrying out a reaction on the composition for about one hour to about eight hours under exposure to heat and/or light.

The composition may further include fumed silica.

With respect to the total weight of the composition, the fumed silica may be included in an amount of about 30 wt % or less.

The composition may include glass fiber, glass powder, carbon nanotube, graphene oxide, carbonyl iron, CaCO₃, CaO, and/or ZnO.

The composition may include silicone elastomer, polydimethylsiloxane (PDMS), polymethyl methacrylate (PMMA), and/or an acrylic resin.

The polymer layer may have a gel point at which a storage modulus is the same as a loss modulus at a first frequency of about 0.1 Hz to about 100 Hz.

The loss modulus may be greater than the storage modulus at a frequency less than the first frequency corresponding to the gel point, the storage modulus may be greater than the loss modulus at a frequency greater than the first frequency, and the storage modulus and the loss modulus may each be measured according to the ASTM D4440 method.

In the polymer layer, the storage modulus may increase as a frequency increases.

A display device includes a display panel and a protective film disposed on the display panel. The protective film includes a first base layer, a second base layer disposed on the first base layer, and a polymer layer disposed between the first base layer and the second base layer. The polymer layer is derived from a composition including polyborondimethylsiloxane and benzoyl peroxide, and the polymer layer has a light transmittance of about 84% or more in a wavelength range of about 400 nm to about 800 nm.

The protective film may further include a third base layer disposed between the first base layer and the second base layer and an intermediate layer disposed between the first base layer and the third base layer or between the second base layer and the third base layer. The intermediate layer may include a polymer derived from the composition or a pressure sensitive adhesive.

The protective film may further include a first sub intermediate layer disposed between the polymer layer and the second base layer and a second sub intermediate layer disposed between the first sub intermediate layer and the second base layer or between the first base layer and the polymer layer. Each of the first sub intermediate layer and the second sub intermediate layer may include a polymer derived from the composition or a pressure sensitive adhesive.

The display device may further include a window disposed between the display panel and the protective film and a window polymer layer disposed between the display panel and the window and derived from the composition.

The polymer derived from the composition may have shear thickening properties such that a storage modulus may increase when external force is applied.

The composition may further include fumed silica, and with respect to the total weight of the composition, the fumed silica may be included in an amount of about 30 wt % or less.

The composition may further include glass fiber, glass powder, carbon nanotube, graphene oxide, carbonyl iron, CaCO₃, CaO, and/or ZnO.

The composition may further include silicone elastomer, polydimethylsiloxane (PDMS), polymethyl methacrylate (PMMA), and/or an acrylic resin.

The polymer layer may have a first storage modulus in a first state and may have a second storage modulus in a second state after external force is applied thereto. The second storage modulus may be about 10 times to about 12,000 times as large as the first storage modulus.

The polymer layer may have a haze value of about 0.1% to about 10%.

The polymer layer may have a thickness of about 10 μm to about 1000 μm.

A second thickness of the second base layer may be greater than a first thickness of the first base layer.

Each of the first base layer and the second base layer may include polyethylene terephthalate (PET), polybutylene terephthalate (PBT), polyethylene naphthalate (PEN), polycarbonate (PC), polymethyl methacrylate (PMMA), polyethersulfone (PES), polyamide (PA), modified-polyphenylene oxide (m-PPO), polyoxymethylene (POM), polyamide-imide (PAI), polyether block amide (PEBA), and/or polyarylate, (PAR).

The display panel may be foldable with respect to at least one folding axis.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is a perspective view of a display device according to an embodiment of the present disclosure;

FIG. 1B is a perspective view of a display device according to an embodiment of the present disclosure;

FIG. 2 is a cross-sectional view illustrating a portion taken along line I-I′ of FIG. 1A;

FIG. 3A is a cross-sectional view illustrating a protective film according to an embodiment of the present disclosure;

FIG. 3B is a cross-sectional view illustrating a protective film according to an embodiment of the present disclosure;

FIG. 3C is a cross-sectional view illustrating a protective film according to an embodiment of the present disclosure;

FIG. 3D is a cross-sectional view illustrating a protective film according to an embodiment of the present disclosure;

FIG. 4A is a graph showing a storage modulus and a loss modulus versus a frequency in a polymer layer according to a comparative example;

FIG. 4B is a graph showing a storage modulus and a loss modulus versus a frequency in a polymer layer according to an embodiment of the present disclosure;

FIG. 5 is a graph showing a storage modulus and a loss modulus of a polymer layer according to frequency;

FIG. 6 is a graph showing a storage modulus and a loss modulus of a polymer layer according to frequency;

FIG. 7 is a graph showing a storage modulus and a loss modulus of a polymer layer according to frequency;

FIG. 8 is a graph showing a storage modulus and a loss modulus of a polymer layer according to frequency;

FIG. 9A is a graph showing a force over time in a protective film according to a comparative example;

FIG. 9B is a graph showing a force over time in a protective film according to an embodiment of the present disclosure;

FIG. 10A is a graph showing a load versus a displacement in a protective film according to a comparative example; and

FIG. 10B is a graph showing a load versus a displacement in a protective film according to an embodiment of the present disclosure.

### DETAILED DESCRIPTION

As the inventive concept allows for various changes and numerous embodiments, particular embodiments will be illustrated in the drawings and described in detail in the following description. However, the present invention is not necessarily limited to the embodiments described and shown herein, and the present invention should be understood to include all changes, equivalents, and substitutes included in the spirit and scope of the present disclosure.

It will be understood that when an element (or a region, a layer, a portion, etc.) is referred to as being “on”, “connected to” or “coupled to” another element, it can be directly disposed on, connected or coupled to the other element or intervening elements may be present therebetween.

Like reference numerals or symbols may refer to like elements throughout the specification and the disclosure. In addition, in the drawings, the thicknesses, the ratios, and the dimensions of elements may be exaggerated for effective explanation of technical contents. However, it is to be understood that in the drawings, the relative thicknesses, angles, dimensions, sizes, shapes, etc. are indeed intended to represent at least one embodiment of the present disclosure and so the geometric relationships shown should be understood to be part of the disclosure. The term “and/or” includes all combinations of one or more of the associated elements.

It will be understood that, although the terms first, second, etc. may be used herein to describe various elements, the elements should not necessarily be limited by these terms. These terms are exclusively used to distinguish one element from another element. For example, a first element could be termed as a second element, and similarly, the second element could be termed as the first element. The singular forms are intended to include the plural forms as well, unless the context clearly indicates otherwise.

In addition, the terms “below”, “beneath”, “on” and “above” are used for explaining the relation of elements illustrated in the drawings. The terms are relative concept and are explained based on the direction illustrated in the drawing.

It will be further understood that the terms “comprises” and/or “comprising,” when used in this specification, specify the presence of stated features, numerals, steps, operations, elements, parts, or the combination thereof, but do not preclude the presence or addition of one or more other features, numerals, steps, operations, elements, parts, or the combination thereof.

Hereinafter, a polymer layer of an embodiment of the present disclosure and a display device of an embodiment of the present disclosure will be described with reference to the accompanying drawings.

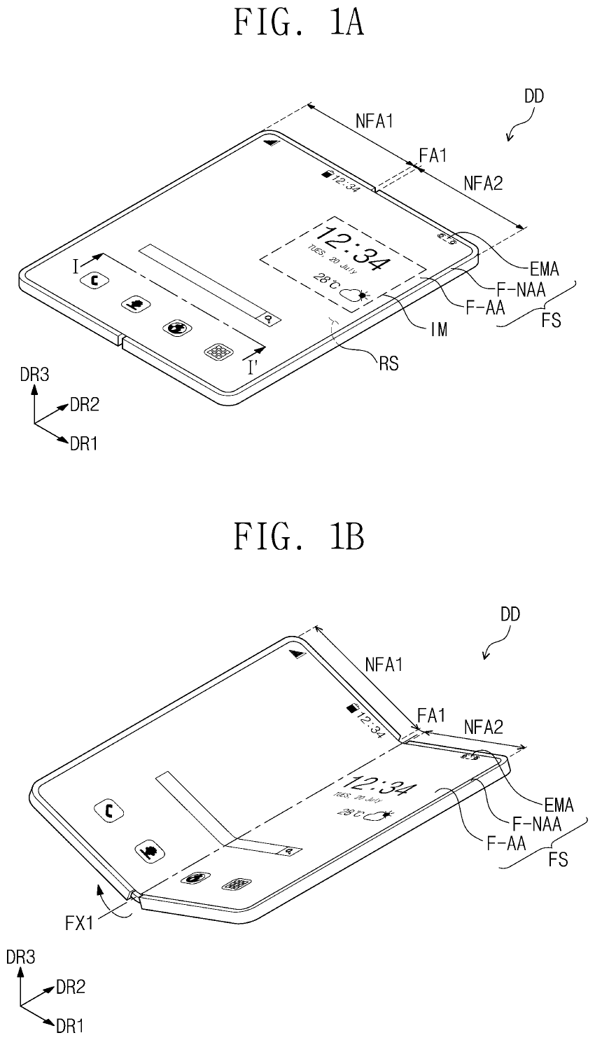

FIG. 1A and FIG. 1B each are perspective views illustrating a display device DD of an embodiment of the present disclosure. FIG. 1B illustrates the display device illustrated in FIG. 1A being in an in-folded state.

The display device DD may be activated in response to electrical signals. For example, the display device DD may be incorporated into a personal digital terminal, a tablet PC, an automobile navigation unit, a game machine or a wearable device. However, the present invention is not necessarily limited thereto. FIG. 1A and FIG. 1B exemplarily illustrate the display device DD is incorporated into a portable electronic device.

The display device DD, according to an embodiment of the inventive concept, may be flexible. “Flexibility” refers to a bendable property and may include any property of being completely bent or of being bent to a level of several nanometers without sustaining cracking or other forms of damage. For example, the display device DD may be a foldable display device. In addition, the display device DD may be a rigid display device.

A thickness direction of the display device DD may be in a third direction axis DR3 which is a normal direction for a plane that is defined by a first direction axis DR1 and a second direction axis DR2. Directions indicated by the first to third direction axes DR1, DR2 and DR3 described herein are relative concepts and may thus be changed into different directions. In addition, the directions indicated by the first to third direction axes DR1, DR2 and DR3 may be described as first to third directions, and the same reference numerals or symbols may be used therefor. In this specification, the first direction axis DR1 and the second direction axis DR2 may be perpendicular to each other, and the third direction axis DR3 may be a normal direction for a plane defined by the first direction axis DR1 and the second direction axis DR2.

The display device DD may include a first display surface FS in a plane defined by the first direction axis DR1 and the second direction axis DR2 crossing the first direction axis DR1. The display device DD may display an image IM via the display surface FS. The display device DD may display an image IM in a direction of the third direction axis DR3 on the first display surface FS that extends in the first direction axis DR1 and the second direction axis DR2.

The display device DD may include a first display surface FS and a second display surface RS. The first display surface FS may include a first active region F-AA and a first peripheral region F-NAA. The first active region F-AA may include a module region EMA. The display device DD may include an electronic module disposed corresponding to the module region EMA. For example, the electronic module may include a camera, a light detection sensor, and/or a heat detection sensor.

The display device DD may display an image IM via the first active region F-AA. In addition, the first active region F-AA may sense external inputs in various forms. The first peripheral region F-NAA may be adjacent to the first active region F-AA. The first peripheral region F-NAA may at least partially surround the first active region F-AA. The shape of the first active region F-AA may be substantially defined by the first peripheral region F-NAA. Unlike the configuration illustrated in FIG. 1A, the first peripheral region F-NAA may be disposed adjacent to only one side of the first active region F-AA or the first peripheral region F-NAA may be omitted. The display device DD may include active regions having various shapes, and the display device DD, according to the present invention, is not necessarily limited to any one embodiment of the present disclosure.

The second display surface RS may be defined as a surface that faces at least a portion of the first display surface FS. The second display surface RS may be defined as a portion of the rear surface of the display device DD.

The display device DD may include a folding region FA1 and non-folding regions NAF1 and NFA2. The display device DD may include a first non-folding region NFA1 and a second non-folding region NFA2 with one folding region FA1 disposed therebetween. However, this particular arrangement is provided as an example, and the number of folding regions and the number of non-folding regions are not necessarily limited thereto.

FIG. 1B is a perspective view illustrating an in-folding process of the display device DD of FIG. 1A. The display device DD may be folded with respect to a folding axis FX1 in the second direction axis DR2. FIG. 1B illustrates one folding axis FX1, but the number of folding axes in the display device DD of an embodiment of the present disclosure is not necessarily limited thereto.

When the display device DD is in-folded, the top surfaces of the first non-folding region NFA1 and the second non-folding region NFA2 may face each other. When the display device DD is in-folded, the first display surface FS might be hidden from a user and the second display surface RS (e.g., the rear surface) may be exposed to a user. The display device DD may be out-folded such that the first display surface FS is exposed and the second display surface RS is not exposed. Thus, in the in-folded state, the viewing surfaces of the display device might be protected by being folded up against one another while in the out-folded state, the viewing surfaces of the display device might remain viewable. Although, according to some embodiments of the present disclosure, a separate display may be disposed on the second display surface RS such that even when in the in-folded state, a display (e.g., a display pay) remain visible.

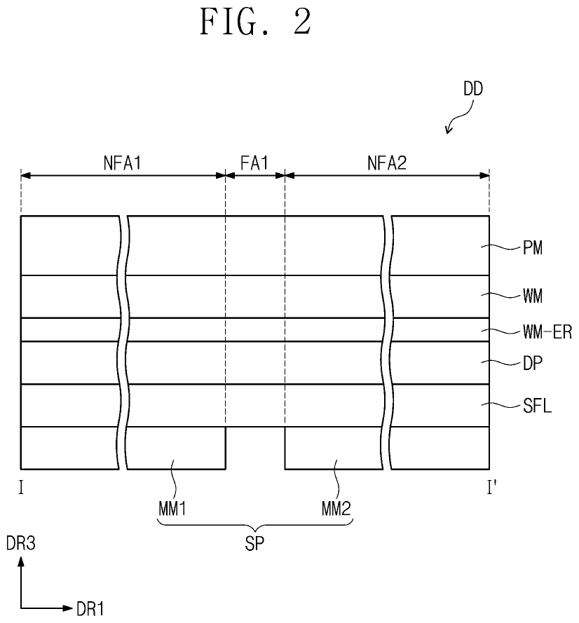

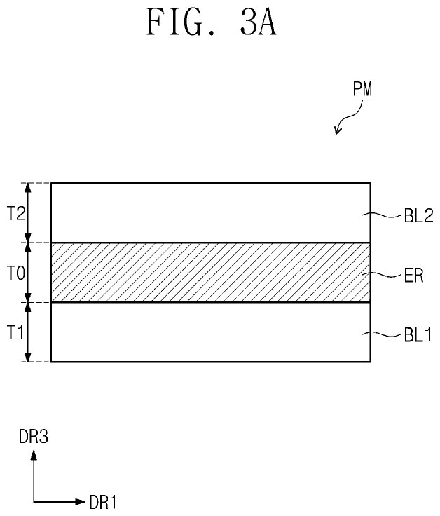

FIG. 2 is a cross-sectional view illustrating a portion taken along line I-I′ of FIG. 1A. The display device DD of an embodiment of the present disclosure may include a display panel DP and a protective film PM disposed on the display panel DP. The protective film PM will be described in detail later.

In addition, the display device DD may include a window polymer layer WM-ER and a window WM disposed between the display panel DP and the protective film PM. A supplementary functional layer SFL and a support member SP may be disposed below the display panel DP.

The support member SP may include a first support member MM1 and a second support member MM2. The first support member MM1 and the second support member MM2 may be spaced apart from each other in a direction in which the first direction axis DR1 extends. The support member SP may overlap the non-folding regions NFA1 and NFA2 and might not overlap the folding region FA1. The first support member MM1 may overlap the first non-folding region NFA1 and might not overlap the folding region FA1. The second support member MM2 may overlap the second non-folding region NFA2 and might not overlap the folding region FA1. However, the present invention is not necessarily limited thereto, and each of the first support member MM1 and the second support member MM2 may at least partially overlap the folding region FA1.

The support member SP may include a single layer or multiple layers. The support member SP may include a heat dissipation member, a shielding member, and/or an insulating member. The first support member MM1 and the second support member MM2 may each be made of a metal alloy. For example, the first support member MM1 and the second support member MM2 may each include stainless steel, aluminum, copper or an alloy thereof. However, this is an example, and materials included in the first support member MM1 and the second support member MM2 are not necessarily limited thereto.

The supplementary functional layer SFL may be disposed on an upper side of the support member SP. The supplementary functional layer SFL may include a single layer or multiple layers. For example, the supplementary functional layer SFL may include cushion layer, a barrier layer, and/or a protective layer. The supplementary functional layer SFL may include a cushion layer made of foam or sponge. The supplementary functional layer SFL may include a barrier layer which prevents the deformation of the display panel DP. The supplementary functional layer SFL may include a colored polyimide film as a protective layer. However, this is an example, and materials included in the supplementary functional layer SFL and a function of the supplementary functional layer SFL are not necessarily limited thereto.

The display panel DP may be disposed on the supplementary functional layer SFL. The display panel DP may be foldable with respect to a folding axis FX1 (FIG. 1B). The display panel DP may include a display element layer. For example, the display element layer may include an organic light emitting element, a quantum dot light emitting element, or a liquid crystal element layer. However, this is an example, and an embodiment of the inventive concept is not necessarily limited thereto.

The window WM may be optically transparent. The window WM may include a single layer or multiple layers. For example, the window WM may include glass or a polyimide (PI) resin. However, this is an example, and materials included in the window WM are not necessarily limited thereto.

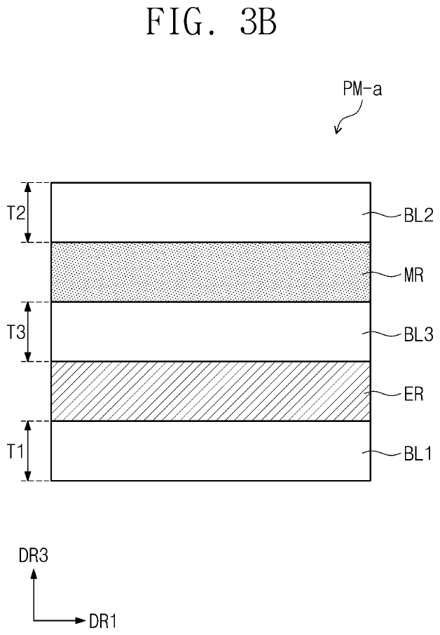

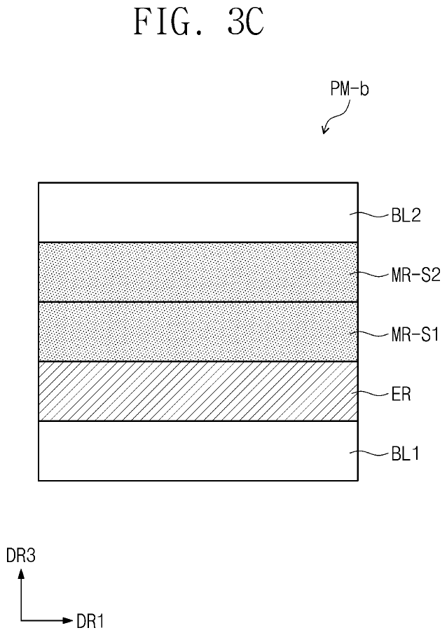

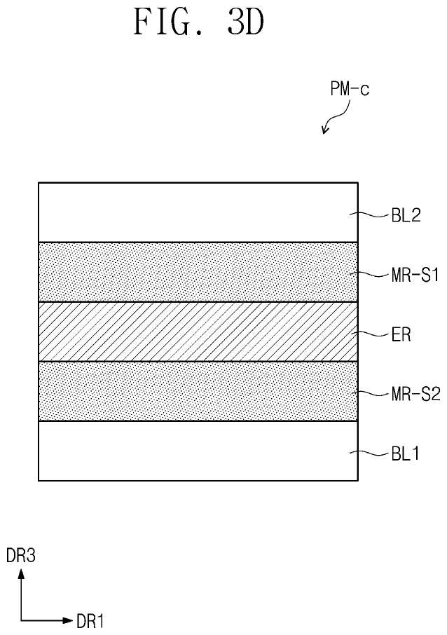

The window polymer layer WM-ER may be disposed between the window WM and the display panel DP. The window polymer layer WM-ER may bond the window WM to a component adjacent to the window WM. For example, the window WM and the display panel DP may be bonded to each other by the window polymer layer WM-ER. The window polymer layer WM-ER may include the same material as a polymer layer ER (FIG. 3A) of the protective film PM to be described later or may include a pressure sensitive adhesive (PSA). However, an embodiment of the inventive concept is not necessarily limited thereto, and the window polymer layer WM-ER may include an optically clear adhesive (OCA) or an optically clear resin (OCR). In addition, unlike the configuration illustrated herein, the window polymer layer WM-ER may be omitted.

FIG. 3A to FIG. 3D each are cross-sectional views illustrating protective films PM, PM-a, PM-b and PM-c according to an embodiment of the present disclosure. The protective film PM of an embodiment of the present disclosure may include a first base layer BL1, a second base layer BL2 disposed on the first base layer BL1, and a polymer layer ER disposed between the first base layer BL1 and the second base layer BL2. The protective films PM, PM-a, PM-b, and PM-c may each include one polymer layer ER or a plurality of polymer layers.

The polymer layer ER may be derived from (e.g., including in whole or in part) a composition including polyborondimethylsiloxane and benzoyl peroxide. The polymer layer ER may be formed from an addition reaction of benzoyl peroxide to polyborondimethylsiloxane. The polymer layer ER may have a transmittance of about 84% or more in a wavelength range of about 400 nm to about 800 nm. The protective film PM including the polymer layer ER, according to an embodiment of the present disclosure, may be optically transparent and may exhibit increased impact resistance. The position of the polymer layer ER is not necessarily limited to those illustrated in FIG. 3A to FIG. 3D, and the polymer layer ER may also be disposed at another position on the display panel that requires impact resistance and optical transparency.

Referring to FIG. 3A, the protective film PM may include the first base layer BL1, the polymer layer ER, and the second base layer BL2 which are sequentially stacked. The second base layer BL2 may be disposed on the uppermost portion of the display device DD, and the first base layer BL1 may be disposed adjacent to the display panel DP. For example, an upper surface of the second base layer BL2 may be a surface that is exposed to a user.

The first base layer BL1 and the second base layer BL2 may each be optically transparent. For example, each of the first base layer BL1 and the second base layer BL2 may include polyethylene terephthalate (PET), polybutylene terephthalate (PBT), polyethylene naphthalate (PEN), polycarbonate (PC), polymethyl methacrylate (PMMA), polyethersulfone (PES), polyamide (PA), modified-polyphenylene oxide (m-PPO), polyoxymethylene (POM), polyamide-imide (PAI), polyether block amide (PEBA), and/or polyarylate, (PAR). However, this is an example, and materials included in the first base layer BL1 and the second base layer BL2 are not necessarily limited thereto.

The first base layer BL1 may have a first thickness T1 and the second base layer BL2 may have a second thickness T2. For example, the second thickness T2 of the second base layer BL2 may be greater than the first thickness T1 of the first base layer BL1. The second thickness T2 of the second base layer BL2 adjacent to an uppermost portion of the protective film PM may be greater than the first thickness T1 of the first base layer BL1. For example, the second thickness T2 of the second base layer BL2 may be about 80 μm to about 120 μm. The first thickness T1 of the first base layer BL1 may be about 30 μm to about 50 μm. For example, the first thickness T1 of the first base layer BL1 may be about 40 μm and the second thickness T2 of the second base layer BL2 may be about 100 μm.

Alternatively, the second thickness T2 of the second base layer BL2 may be similar to the first thickness T1 of the first base layer BL1. For example, each of the second thickness T2 of the second base layer BL2 and the first thickness T1 of the first base layer BL1 may be about 30 μm to about 50 μm. For example, the second thickness T2 of the second base layer BL2 and the first thickness T1 of the first base layer BL1 may each be about 40 μm. However, this is an example, and the first thickness T1 of the first base layer BL1 and the second thickness T2 of the second base layer BL2 are not necessarily limited to any one embodiment of the present disclosure.

The polymer layer ER may be disposed between the first base layer BL1 and the second base layer BL2. The polymer layer ER may bond adjacent components disposed thereabove and therebelow to one another. The polymer layer ER may bond the first base layer BL1 and the second base layer BL2 to each other.

A thickness T0 of the polymer layer ER may be about 10 μm to about 1000 μm. For example, the thickness T0 of the polymer layer ER may be about 10 μm to about 200 μm. For example, the thickness T0 of the polymer layer ER may be about 50 μm. However, this is an example, and the thickness T0 of the polymer layer ER is not necessarily limited thereto. When the thickness of a polymer layer included in the protective film is about 10 μm or less, the protective film may be vulnerable to impact. When the thickness of a polymer layer included in the protective film is greater than about 1000 μm, the thickness of the display device increase, thereby causing a folding property thereof to be deteriorated. The polymer layer ER having a thickness T0 of about 10 μm to about 1000 μm might not affect the thickness of the display device DD and thus exhibit increased impact resistance. Moreover, the reliability of the polymer layer ER having a thickness T0 of about 10 μm to about 1000 μm may be maintained even when folding and unfolding operations of the display device DD are repeatedly performed.

The polymer layer ER may have a haze value of about 0.1% to about 10%. A polymer layer ER having a haze value of about 0.1% to about 10% may be optically transparent. Accordingly, the reliability of the display quality of the display device DD including the polymer layer ER may be maintained.

In an embodiment of the present disclosure, the polymer layer ER may be derived from (e.g., may include in whole or in part) a composition including polyborondimethylsiloxane and benzoyl peroxide. The polyborondimethylsiloxane may be formed through a condensation polymerization reaction between polydimethylsiloxane and boric acid. In the condensation polymerization reaction, the mass ratio of the polydimethylsiloxane to the boric acid may be about 25:1 to about 500:1. For example, the mass ratio of the polydimethylsiloxane to the boric acid may be about 25:1, about 50:1, about 250:1, or about 500:1. However, this is an example, and an embodiment of the inventive concept is not necessarily limited thereto. The polyborondimethylsiloxane formed through the condensation polymerization reaction between the polydimethylsiloxane and the boric acid may include a repeating unit of Formula 1 below.

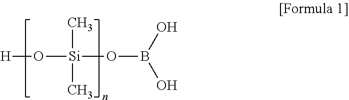

In Formula 1, n may be a positive integer. The polyborondimethylsiloxane may be formed by the bond of an oxygen atom of a hydroxyl group included in the polydimethylsiloxane with a boron atom of a boric acid. The polydimethylsiloxane may include a hydroxyl group at a terminal end thereof, and the hydroxyl group may be bonded to a silicon atom. In addition, in Formula 1, two hydroxyl groups bonded to the boron atom may be additionally bonded to oxygen atoms of the hydroxyl group included in the polydimethylsiloxane through the condensation polymerization reaction. The polymer layer ER of an embodiment of the present disclosure may be prepared by adding the benzoyl peroxide to the polyborondimethylsiloxane.

The benzoyl peroxide may be a thermal initiator or a photoinitiator, and Si—O—B bonds included in the polyborondimethylsiloxane may be decomposed or produced by the benzoyl peroxide. At least one Si—O—B bond among a plurality of Si—O—B bonds may be decomposed by the benzoyl peroxide, and the decomposition of the bond may generate energy. Another Si—O—B bond may be produced by absorbing energy resulting from the decomposition of the Si—O—B bond.

The decomposition and production of a Si—O—B bond by the benzoyl peroxide may be a reversible reaction. However, when external force is applied to a polymer layer after the polymer layer is formed from the composition including polydimethylsiloxane and benzoyl peroxide, the decomposition and production of a Si—O—B bond by the benzoyl peroxide may no longer occur. The external force is a force that causes a change in the state of the polymer layer and may be shear stress. When the external force is applied, a state of the polymer layer is changed from a fluid state to a solid state. The external force that causes a change in the state of the polymer layer may be greater than the force applied during folding and unfolding of a device.

For example, a composition for forming the polymer layer ER may include the polyborondimethylsiloxane and the benzoyl peroxide at a mass ratio of about 8:1 to about 53:1. For example, the composition for forming the polymer layer ER may include the polyborondimethylsiloxane and the benzoyl peroxide at a mass ratio of about 10.5:1 to about 52.5:1. The polymer layer ER formed from the composition including the polyborondimethylsiloxane and the benzoyl peroxide at the mass ratio of about 8:1 to about 52.5:1 may have greater impact resistance while maintaining optical transparency.

The polymer layer ER may be formed by reacting the polyborondimethylsiloxane with the benzoyl peroxide for about one hour to about eight hours. During the reaction of the polyborondimethylsiloxane with the benzoyl peroxide for the formation of the polymer layer ER, heat or light may be supplied. For example, heat having a temperature of about 80° C. to about 100° C. may be supplied. However, this is an example, and the temperature of the supplied heat is not necessarily limited thereto.

When the reaction time is shorter than about one hour, a chemical reaction between the polyborondimethylsiloxane and the benzoyl peroxide might not satisfactorily proceed, and thus, the polymer layer may have durability that is not suitable as a component of a display device. In addition, when the reaction time is longer than about eight hours, the time required for forming the polymer layer becomes greatly elongated, and thus manufacturing efficiency may be deteriorated. Therefore, the polymer layer ER formed by reacting the polyborondimethylsiloxane with the benzoyl peroxide for about one hour to about eight hours may maintain the reliability of the display device DD, so that manufacturing efficiency may be maintained at a satisfactory level.

The polymer layer ER derived from (e.g., including in whole or in part) the composition including polyborondimethylsiloxane and benzoyl peroxide may have shear thickening properties. When the external force is applied to a shear-thickening material, a storage modulus thereof may increase. The external force that causes an increase in the storage modulus may be a force that causes a phase transition of a shear-thickening material and may be an external impact. Before the external force is applied, the shear-thickening material exhibits a behavior of fluid in which a loss modulus is greater than a storage modulus. After the external force is applied, the shear-thickening material exhibits a behavior of solid in which the storage modulus is greater than the loss modulus. By absorbing the external force, the state of the shear-thickening material may be changed from a state in which the material has a behavior of fluid to a state in which the material has a behavior of solid.

Before the external force is applied, the polymer layer ER with shear thickening properties has a loss modulus that is greater than a storage modulus; however, after the external force is applied, the polymer layer ER with shear thickening properties has a storage modulus that is greater than a loss modulus. Before the external force is applied, the polymer layer ER with shear thickening properties exhibits a behavior that is similar to that of fluid; however, after the external force is applied, the polymer layer ER with shear thickening properties exhibits a behavior that is similar to that of solid.

When the external impact is applied, the polymer layer ER with shear thickening properties of an embodiment of the present disclosure may prevent damage to components included in the display device DD by absorbing the external impact. The polymer layer ER with shear thickening properties of an embodiment of the present disclosure may absorb impact, and thus, the protective film PM including the polymer layer ER may exhibit increased impact resistance. In addition, the polymer layer ER derived from (e.g., including in whole or in part) the composition including polyborondimethylsiloxane and benzoyl peroxide may have relatively high adhesive strength. Accordingly, the display device DD including the polymer layer ER may exhibit properties of maintaining reliability during repetitive folding and unfolding operations.

In an embodiment of the present disclosure, the polymer layer ER derived from (e.g., including in whole or in part) the composition including polyborondimethylsiloxane and benzoyl peroxide may have a gel point. The gel point is a point at which a storage modulus is the same as a loss modulus, and a first frequency that satisfies the gel point is a frequency of about 0.1 Hz to about 1 Hz. At a frequency that is less than the first frequency that satisfies the gel point, the loss modulus may be greater than the storage modulus. In addition, the polymer layer ER derived from (e.g., including in whole or in part) the composition including polyborondimethylsiloxane and benzoyl peroxide may have a storage modulus greater than a loss modulus, at a frequency greater than the first frequency that satisfies the gel point. As a frequency increases, the storage modulus of the polymer layer ER may increase. Meanwhile, the storage modulus and the loss modulus described herein may be measured according to the ASTM D4440 method.

Before the external force is applied, the polymer layer ER derived from (e.g., including in whole or in part) the composition including polyborondimethylsiloxane and benzoyl peroxide may have a storage modulus that is smaller than a loss modulus; however, after the external force is applied, the polymer layer ER may have the storage modulus that is greater than the loss modulus. For example, a second storage modulus of the polymer layer ER in a second state may be about 10 times to about 12,000 times as great as a storage modulus of the polymer layer ER in a first state. The second state may be a state after the external force is applied to the polymer layer ER, and the first state may be a state before the external force is applied to the polymer layer ER.

For example, at a frequency of less than about 10 Hz, the polymer layer ER derived from (e.g., including in whole or in part) the composition including polyborondimethylsiloxane and benzoyl peroxide may have a loss modulus greater than a storage modulus. In addition, at a frequency greater than about 10 Hz, the polymer layer ER derived from (e.g., including in whole or in part) the composition including polyborondimethylsiloxane and benzoyl peroxide may have a storage modulus greater than a loss modulus. The loss modulus at the frequency of less than about 10 Hz may be smaller than the storage modulus at the frequency greater than about 10 Hz.

At a frequency of about 10 Hz, the polymer layer ER may have the storage modulus and the loss modulus which are the same, and therefore the frequency of about 10 Hz may be the first frequency that satisfies the gel point. However, this is an example, and the first frequency that satisfies the gel point of the polymer layer ER may be a frequency of about 0.1 Hz to about 100 Hz.

The composition for forming the polymer layer ER, according to an embodiment of the present disclosure, may further include silica-containing fiber, silica-containing sponge, and the like. The polymer layer ER formed from the composition which further includes silica-containing fiber, silica-containing sponge, and the like may exhibit increased impact resistance. The silica-containing fibers, the silica-containing sponge, and the like may function as fillers, thereby contributing to the increase of impact resistance of the polymer layer ER derived from (e.g., including in whole or in part) the composition which further includes the silica-containing fiber, silica-containing sponge, and the like.

In an embodiment of the present disclosure, the composition for forming the polymer layer ER may further include fumed silica. The fumed silica is nano-sized silica, and the optical transparency of the polymer layer ER derived from (e.g., including in whole or in part) a composition including the fumed silica may be maintained. In addition, the fumed silica functions as a filler, and thus, the impact resistance of the polymer layer ER derived from (e.g., including in whole or in part) the composition including the fumed silica may be increased. For example, with respect to the total weight of the composition, the fumed silica may be included in an amount of about 30 wt % or less. For example, with respect to the total weight of the composition, the fumed silica may be included in an amount of about 5 wt % to about 30 wt %. With respect to the total weight of the composition, the fumed silica contained in an amount of greater than about 30 wt % might not be easily mixed with the composition.

The composition for forming the polymer layer ER may further include glass fiber, glass powder, carbon nanotube, graphene oxide, carbonyl iron, CaCO₃, CaO, and/or ZnO. The composition for forming the polymer layer ER may further include a filler such as glass fiber, glass powder, CaCO₃, CaO, and ZnO. The polymer layer ER formed from a composition which includes an inorganic filler such as glass fiber and glass powder may exhibit increased impact resistance. The composition for forming the polymer layer ER may exhibit conductivity by further including a filler such as carbon nanotube and graphene oxide. The composition for forming the polymer layer ER may exhibit magnetism by further including carbonyl iron and the like.

In addition, the composition for forming the polymer layer ER may further include silicone elastomer, polydimethylsiloxane (PDMS), polymethyl methacrylate (PMMA), and/or an acrylic resin. The polydimethylsiloxane may be a material that is different from polydimethylsiloxane provided to prepare polyborondimethylsiloxane. The polydimethylsiloxane that the polymer layer ER further includes may have the same constitution elements as the polydimethylsiloxane provided to prepare polyborondimethylsiloxane, but may have a different binding site in a molecule. The silicone elastomer, the polydimethylsiloxane (PDMS), the polymethyl methacrylate (PMMA) and the acrylic resin may be present to have an interpenetrating polymer network (IPM) structure within the polymer layer ER. Accordingly, the polymer layer ER of an embodiment of the present disclosure may exhibit increased impact resistance. However, this is an example, and materials included in the composition for forming the polymer layer ER are not necessarily limited thereto.

Meanwhile, as described above, the window polymer layer WM-ER (FIG. 2) may be formed of the same material as the polymer layer ER of the protective film PM. In an embodiment of the present disclosure, the window polymer layer WM-ER may include a polymer derived from (e.g., including in whole or in part) a composition including polyborondimethylsiloxane and benzoyl peroxide. The window polymer layer WM-ER including the polymer derived from (e.g., including in whole or in part) the composition including polyborondimethylsiloxane and benzoyl peroxide may have a transmittance of about 84% or more in a wavelength range of about 400 nm to about 800 nm. In addition, the window polymer layer WM-ER, which is formed of the same material as the polymer layer ER of the protective film PM, may exhibit increased impact resistance.

The protective film PM-A of an embodiment of the present disclosure may further include a third base layer BL3 and an intermediate layer MR. The third base layer BL3 may be disposed between the first base layer BL1 and the second base layer BL2. The intermediate layer MR may be disposed between the first base layer BL1 and the third base layer BL3 or between the third base layer BL3 and the second base layer BL2.

FIG. 3B illustrates that the intermediate layer MR is disposed between the third base layer BL3 and the second base layer BL2. The protective film PM-a may include the first base layer BL1, the polymer layer ER, the third base layer BL3, the intermediate layer MR, and the second base layer BL2 which are sequentially stacked. The third base layer BL3 may include the same material as the first base layer BL1 and/or the second base layer BL2. Alternatively, the third base layer BL3 may include a material different from that of at least one of the first base layer BL1 or the second base layer BL2.

The third base layer BL3 may be formed to a thickness equal to that of the first base layer BL1. The third base layer BL3 may have a third thickness T3 of about 30 μm to about 50 μm. However, this is an example and the third thickness T3 of the third base layer BL3 is not necessarily limited thereto.

For example, the third base layer BL3 may include polyethylene terephthalate (PET), polybutylene terephthalate (PBT), polyethylene naphthalate (PEN), polycarbonate (PC), polymethyl methacrylate (PMMA), polyethersulfone (PES), polyamide (PA), modified-polyphenylene oxide (m-PPO), polyoxymethylene (POM), polyamide-imide (PAI), polyether block amide (PEBA), and/or polyarylate, (PAR). However, this is an example and a material included in the third base layer BL3 is not necessarily limited thereto.

The intermediate layer MR may bond the third base layer BL3 to the second base layer BL2. In an embodiment of the present disclosure, the intermediate layer MR may include a polymer derived from (e.g., including in whole or in part) a composition including polyborondimethylsiloxane and benzoyl peroxide or include a pressure sensitive adhesive (PSA). For example, the intermediate layer MR and the polymer layer ER may be formed from the same composition. The protective film PM-a may include a plurality of layers formed from the composition including polyborondimethylsiloxane and benzoyl peroxide.

Referring to FIG. 3C and FIG. 3D, the protective film PM-b and the protective film PM-c may each further include a first sub intermediate layer MR-S1 and a second sub intermediate layer MR-S2. The first sub intermediate layer MR-S1 may be disposed between the polymer layer ER and the second base layer BL2. The second sub intermediate layer MR-S2 may be disposed between the first sub intermediate layer MR-S1 and the second base layer BL2 or between the first base layer BL1 and the polymer layer ER.

FIG. 3C illustrates that the second sub intermediate layer MR-S2 is disposed between the first sub intermediate layer MR-S1 and the second base layer BL2. The first sub intermediate layer MR-S1 and the second sub intermediate layer MR-S2 may be stacked on the polymer layer ER. The protective film PM-b may include the first base layer BL1, the polymer layer ER, the first sub intermediate layer MR-S1, the second sub intermediate layer MR-S2, and the second base layer BL2 which are sequentially stacked.

Alternatively, FIG. 3D illustrates that the second sub intermediate layer MR-S2 is disposed between the first base layer BL1 and the polymer layer ER. The first sub intermediate layer MR-S1 may be disposed on the polymer layer ER, and the second sub intermediate layer MR-S2 may be disposed under the polymer layer ER. The protective film PM-c may include the first base layer BL1, the second sub intermediate layer MR-S2, the polymer layer ER, the first sub intermediate layer MR-S1, and the second base layer BL2 which are sequentially stacked. Meanwhile, unlike the configuration illustrated herein, either of the first sub intermediate layer MR-S1 or the second sub intermediate layer MR-S2 may be omitted.

According to an embodiment of the present disclosure, each of the first sub intermediate layer MR-S1 and the second sub intermediate layer MR-S2 may include a polymer derived from (e.g., including in whole or in part) a composition including polyborondimethylsiloxane and benzoyl peroxide or include a pressure sensitive adhesive (PSA). For example, the first sub intermediate layer MR-S1 and the second sub intermediate layer MR-S2 may each include the pressure sensitive adhesive (PSA).

Alternatively, the first sub intermediate layer MR-S1 and/or the second sub intermediate layer MR-S2 may be formed of the same material as the polymer layer ER. The first sub intermediate layer MR-S1 and/or the second sub intermediate layer MR-S2 may be made of the same material as the polymer layer ER derived from (e.g., including in whole or in part) the composition including polyborondimethylsiloxane and benzoyl peroxide.

In the protective film PM-b illustrated in FIG. 3C, the first sub intermediate layer MR-S1 may include the pressure sensitive adhesive (PSA), and the second sub intermediate layer MR-S2 may be formed of the same material as the polymer layer ER. Alternatively, in the protective film PM-c illustrated in FIG. 3D, the first sub intermediate layer MR-S1 and the second sub intermediate layer MR-S2 may each include the pressure sensitive adhesive (PSA).

Hereinafter, with reference to embodiments of the present disclosure and comparative examples, a polymer layer and a protective film including the polymer layer according to an embodiment of the inventive concept will be described in detail. In addition, Examples to be described below are exemplified to help understand the inventive concept, and the scope of the inventive concept is not necessarily limited thereto.

### Examples

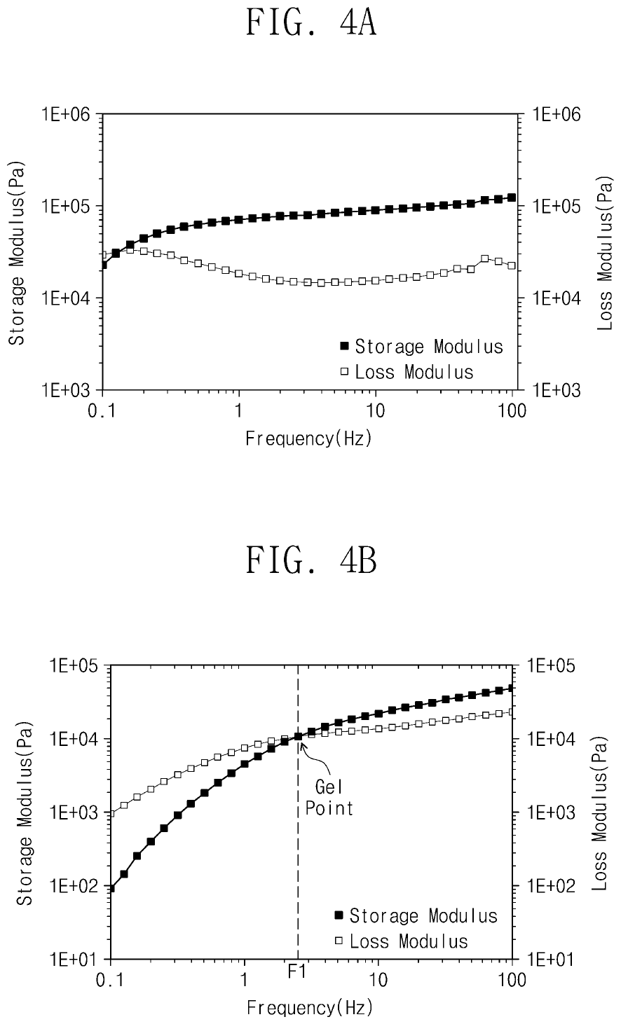

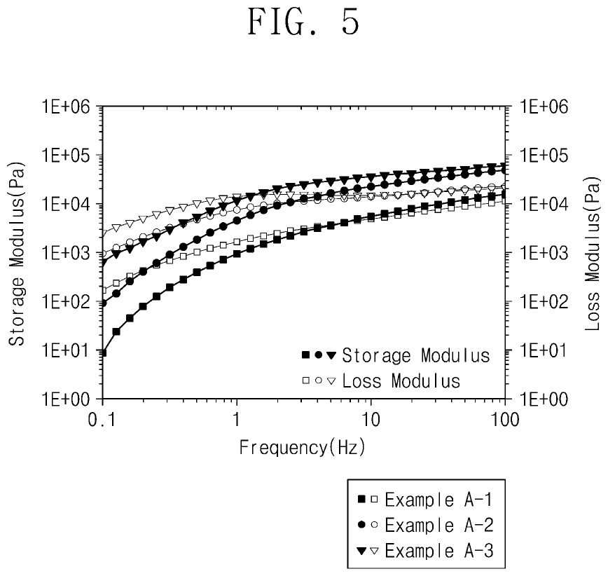

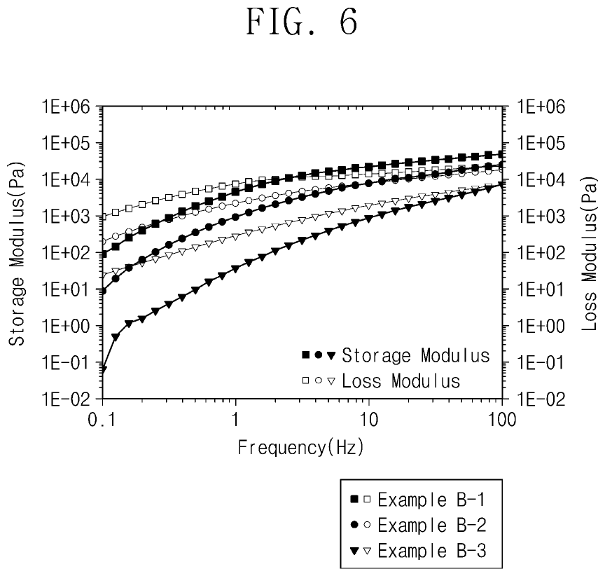

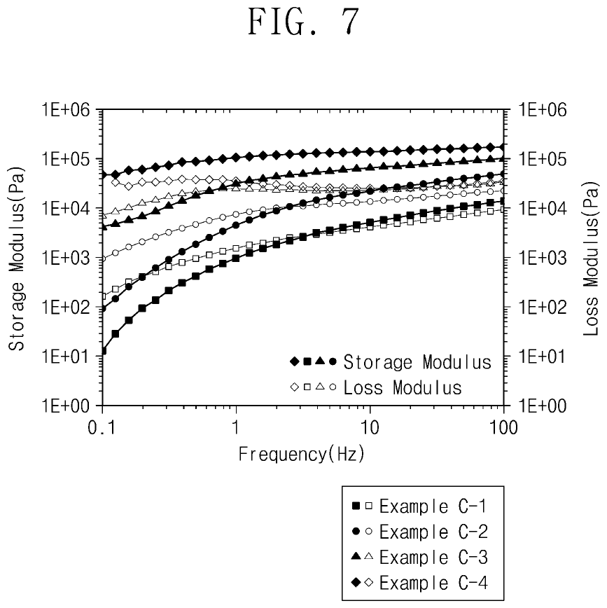

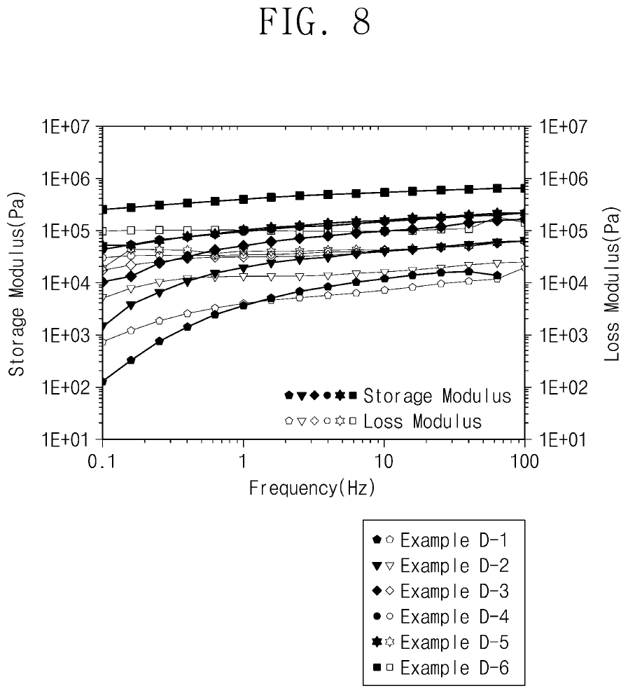

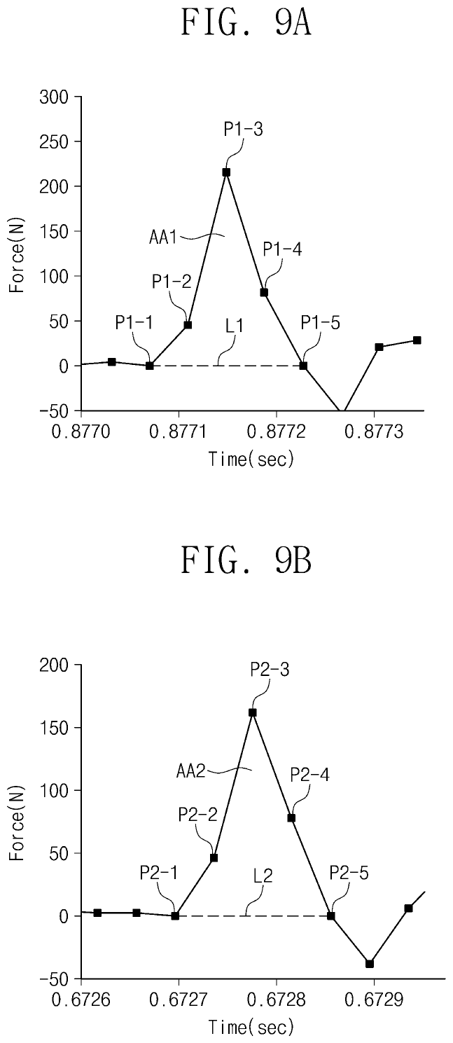

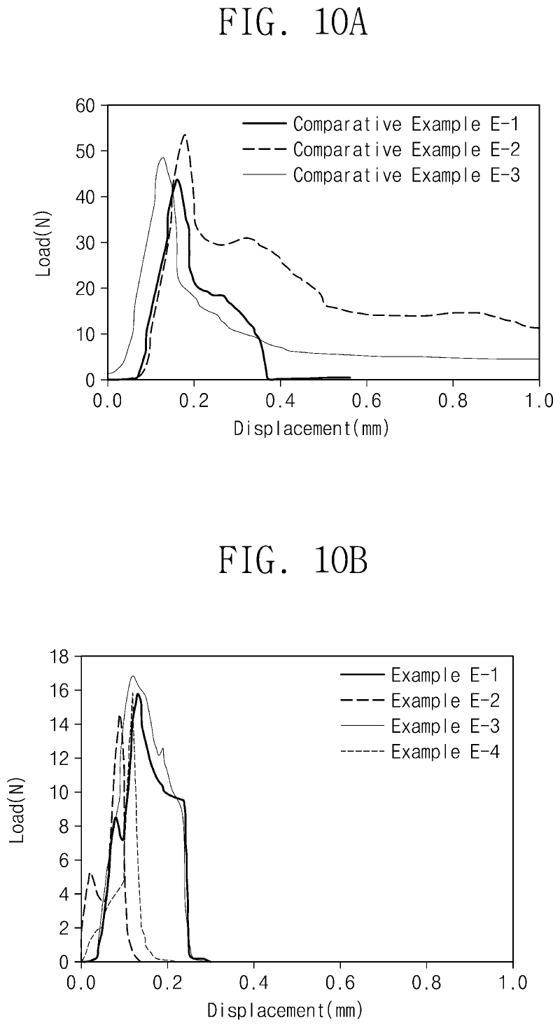

In the graphs of FIGS. 4A and 6B, polymer layers according to comparative examples and embodiments of the present disclosure differ from each other with respect to whether or not compositions for forming the polymer layers according to comparative examples and embodiments of the present disclosure contain benzoyl peroxide. In the graph of FIG. 5, polymer layers according to Examples A-1 to A-3 differ from each other in a time taken for a reaction between polydimethylsiloxane and boric acid that form polyborondimethylsiloxane. In the graph of FIG. 6, polymer layers according to Examples B-1 and B-2 differ from each other in the mass of benzoyl peroxide included in compositions for forming the polymer layers. In the graph of FIG. 7, polymer layers according to Examples C-1 to C-4 differ from each other in the mass of boric acid supplied during preparation of polyborondimethylsiloxane. In the graph of FIG. 8, polymer layers according to Examples D-1 to D-6 further include fumed silica and differ from each other in the mass of the fumed silica which is supplied. In the graphs of FIG. 9A and FIG. 9B, protective films according to comparative examples and embodiments of the present disclosure differ from each other with respect to whether or not to include a polymer layer therein. In the graphs of FIGS. 10A and 10B, protective films according to comparative examples and embodiments of the present disclosure differ from each other whether or not to include a polymer layer therein. FIG. 5 to FIG. 10 will be described in detail later.

FIG. 4A and FIG. 4B are graphs showing a storage modulus and a loss modulus of a polymer layer according to a frequency change. FIG. 4A illustrates a storage modulus and a loss modulus which are measured for a polymer layer according to a comparative example, and the polymer layer according to the comparative example may be prepared from a composition which includes polyborondimethylsiloxane and does not include benzoyl peroxide. The polymer layer according to the comparative example includes polyborondimethylsiloxane which is prepared using about 37.5 g of polydimethylsiloxane, about 5 g of boric acid, and about 2 g of ethanol.

FIG. 4B illustrates a storage modulus and a loss modulus which are measured for a polymer layer according to embodiments of the present disclosure, and the polymer layer according to embodiments of the present disclosure, which is a polymer layer according to an embodiment of the present disclosure, is prepared from a composition including polyborondimethylsiloxane and benzoyl peroxide. The polymer layer according to embodiments of the present disclosure is prepared by preparing polyborondimethylsiloxane from about 37.5 g of polydimethylsiloxane, about 5 g of boric acid, and about 2 g of ethanol, and adding about 1.8 g of benzoyl peroxide to the prepared polydimethylsiloxane.

In FIG. 4A and FIG. 4B, the storage moduli and the loss moduli are the results obtained by using a frequency sweep test and are measured by applying 0.1% strain to the polymer layer at a temperature of about 25° C. The storage moduli and the loss moduli are measured for the polymer layers according to the comparative example and embodiments of the present disclosure, having a thickness of about 1000 μm, by using a 40 mm steel plate.

Referring to FIG. 4A and FIG. 4B, the polymer layer according to embodiments of the present disclosure has a greater amount of change in storage modulus than the polymer layer according to the comparative example. Referring to FIG. 4A, the polymer layer according to the comparative example has a storage modulus of about 10⁴ Pa to about 10⁵ Pa at a frequency of about 0.1 Hz and a storage modulus of about 10⁵ Pa to about 10⁶ Pa at a frequency of about 100 Hz. For example, it may be seen from FIG. 4A that in the polymer layer according to the comparative example, the storage modulus at a frequency of about 100 Hz is about 100 times the storage modulus at a frequency of about 0.1 Hz. The polymer layer according to the comparative example has a storage modulus of about 10⁴ Pa or higher at a frequency of about 0.1 Hz, and thus, might not be suitable as a component of a flexible display device.

Referring to FIG. 4B, it may be seen that the polymer layer, according to embodiments of the present disclosure, has a storage modulus of about 92.476 Pa at a frequency of about 0.1 Hz and a storage modulus of about 48616 Pa at a frequency of about 100 Hz. For example, it may be seen that in the polymer layer according to embodiments of the present disclosure, the storage modulus at a frequency of about 100 Hz is about 525 times as large as the storage modulus at a frequency of about 0.1 Hz. It is determined that the polymer layer according to embodiments of the present disclosure is formed from a composition which includes benzoyl peroxide, and thus has a greater amount of change in storage modulus than the polymer layer according to the comparative example, which is formed from a composition having no benzoyl peroxide.

As described above, it is determined that since the benzoyl peroxide decomposes a Si—O—B bond of polyborondimethylsiloxane, the polymer layer according to embodiments of the present disclosure has a relatively low storage modulus at a frequency of about 0.1 Hz. The polymer layer according to embodiments of the present disclosure, which has a greater amount of change in storage modulus, may exhibit greater shear thickening properties and absorb external impact. Accordingly, the polymer layer derived from (e.g., including in whole or in part) the composition including polyborondimethylsiloxane and benzoyl peroxide may exhibit increased impact resistance.

In addition, in FIG. 4B, it may be confirmed that the polymer layer according to embodiments of the present disclosure has a gel point at which a storage modulus is the same as a loss modulus. In FIG. 4B, a frequency F1 value that satisfies the gel point may be about 3 Hz. It may be seen that in the polymer layer, according to embodiments of the present disclosure, the storage modulus is greater than the loss modulus at a frequency less than the frequency F1 satisfying the gel point, and the storage modulus is greater than the loss modulus at a frequency greater than the frequency F1. Therefore, it may be seen that the polymer layer according to embodiments of the present disclosure exhibits a behavior of fluid at a frequency less than that a frequency that satisfies the gel point, and exhibits a behavior of solid at a frequency greater than the frequency that satisfies the gel point.

FIG. 5 is a graph showing the measurements of a storage modulus and a loss modulus of a polymer layer according to frequency. Polymer layers according to Examples A-1 to A-3 are formed by changing a time of reaction between polyborondimethylsiloxane and benzoyl peroxide. The polymer layers according to Examples A-1 to A-3 are formed from a composition which includes about 52.2 g of polyborondimethylsiloxane and about 1 g of benzoyl peroxide. About 52.2 g of the polyborondimethylsiloxane is formed from about 50 g of polydimethylsiloxane, about 0.2 g of boric acid, and about 2 g of ethanol. When the storage modulus and the loss modulus were measured, the polymer layers according to Examples A-1 to A-3 each having a thickness of about 1000 μm were used.

The polymer layer according to Example A-1 is formed by reacting the polyborondimethylsiloxane with the benzoyl peroxide for about one hour, the polymer layer according to Example A-2 is formed by reacting the polyborondimethylsiloxane with the benzoyl peroxide for about two hours, and the polymer layer according to Example A-3 is formed by reacting the polyborondimethylsiloxane with the benzoyl peroxide for about eight hours.

Referring to FIG. 5, it may be seen that in the polymer layers, according to Examples A-1 to A-3, a difference between a storage modulus at a frequency of about 0.1 Hz and a storage modulus at a frequency of about 100 Hz is maintained at a satisfactory level. For example, it may be seen that the polymer layers according to Examples A-1 to A-3 each have satisfactory shear thickening properties. In addition, it may be seen that the polymer layers according to Examples A-1 to A-3 each have a gel point at which the storage modulus is the same as the loss modulus. It may be seen that in the polymer layers according to Examples A-1 to A-3, a storage modulus is greater than a loss modulus at a frequency less than a frequency that satisfies the gel point. It may be seen that in the polymer layers according to Examples A-1 to A-3, the loss modulus is greater than the storage modulus at a frequency greater than the frequency that satisfies the gel point. Accordingly, the polymer layers according to embodiments of the present disclosure, which are formed by reacting polydimethylsiloxane with benzoyl peroxide for about one hour to about eight hours may exhibit increased impact resistance.

FIG. 6 is a graph showing the measurements of a storage modulus and a loss modulus of a polymer layer according to frequency, and the polymer layer is formed by varying the mass of benzoyl peroxide. When the storage modulus and the loss modulus were measured, polymer layers according to Examples B-1 to B-3 each having a thickness of about 1000 μm were used.

The polymer layer according to Example B-1 is formed from a composition which includes about 52.2 g of polyborondimethylsiloxane and about 1 g of the benzoyl peroxide, and the polymer layer according to Example B-2 is formed from a composition which includes about 52.2 g of the polyborondimethylsiloxane and about 2 g of the benzoyl peroxide. The polymer layer according to Example B-3 is formed from a composition which includes about 52.2 g of the polyborondimethylsiloxane and about 5 g of the benzoyl peroxide. For example, the polymer layers according to Examples B-1 to B-3 are formed from a composition in which the mass ratio of the polyborondimethylsiloxane to the benzoyl peroxide is about 8:1 to about 53:1.

Referring to FIG. 6, it may be seen that in the polymer layers according to Examples B-1 to B-3, which are formed from the composition in which the mass ratio of the polyborondimethylsiloxane to the benzoyl peroxide is about 8:1 to about 53:1, the storage modulus at a frequency of 100 Hz is greater than the storage modulus at a frequency of 0.1 Hz. In addition, it may be seen that the polymer layers according to Examples B-1 to B-3 each have a gel point. It may be seen that the polymer layers according to Examples B-1 to B-3 each exhibit shear thickening properties. Accordingly, the polymer layers according to Examples, which are formed from the composition in which the mass ratio of the polyborondimethylsiloxane to the benzoyl peroxide is about 8:1 to about 53:1, may exhibit increased impact resistance.

FIG. 7 is a graph showing the measurements of a storage modulus and a loss modulus of a polymer layer according to embodiments of the present disclosure versus a frequency by varying the mass of boric acid. Polymer layers according to Examples C-1 to C-4 each including polyborondimethylsiloxane and benzoyl peroxide respectively use different masses of boric acid supplied when the polyborondimethylsiloxane is prepared. In the polymer layer according to Example C-1, the boric acid is supplied in a mass of about 0.1 g with respect to about 50 g of polydimethylsiloxane when the polyborondimethylsiloxane is prepared, and in the polymer layer according to Example C-2, the boric acid is supplied in a mass of about 0.2 g with respect to about 50 g of the polydimethylsiloxane when the polyborondimethylsiloxane is prepared. In the polymer layer according to Example C-3, the boric acid is supplied in a mass of about 1 g with respect to about 50 g of the polydimethylsiloxane when the polyborondimethylsiloxane is prepared, and in the polymer layer according to Example C-4, the boric acid is supplied in a mass of about 2 g with respect to about 50 g of the polydimethylsiloxane when the polyborondimethylsiloxane is prepared.

Referring to FIG. 7, it may be seen that in the polymer layers, according to Examples C-1 to C-4, a storage modulus at a frequency of about 100 Hz is greater than a storage modulus at a frequency of about 0.1 Hz. It may be confirmed that the polymer layers according to Examples C-1 to C-4 each exhibit shear thickening properties. In addition, it may be seen that the polymer layers according to Examples C-1 to C-3 each have a gel point. In the polymer layers according to Examples C-1 to C-3, a loss modulus is greater than a storage modulus at a frequency less than a frequency that satisfies the gel point, and the storage modulus is greater than the loss modulus at a frequency greater than the frequency which satisfies the gel point. Accordingly, the polymer layer formed from a composition in which the mass ratio of the polydimethylsiloxane to the boric acid is about 25:1 to about 500:1 may exhibit increased impact resistance.

FIG. 8 is a graph showing the measurements of a storage modulus and a loss modulus, versus frequency, in polymer layers formed from compositions which have different contents of fumed silica. The storage modulus and the loss modulus are measured for polymer layers according to Examples D-1 to D-6 each having a thickness of about 1000 μm. The polymer layers according to Examples D-1 to D-6 are respectively formed from compositions which include about 52.2 g of polyborondimethylsiloxane and about 1 g of benzoyl peroxide, and into which a different content of the fumed silica is added.

The polymer layer according to Example D-1 is formed from a composition having no fumed silica, and the polymer layer according to Example D-2 is formed from a composition which includes about 5 wt % of the fumed silica with respect to the total weight of the composition. The polymer layer according to Example D-3 is formed from a composition which includes about 10 wt % of the fumed silica with respect to the total weight of the composition, and the polymer layer according to Example D-4 is formed from a composition which includes about 15 wt % of the fumed silica with respect to the total weight of the composition. The polymer layer according to Example D-5 is formed from a composition which includes about 20 wt % of the fumed silica with respect to the total weight of the composition. The polymer layer according to Example D-6 is formed from a composition which includes about 25 wt % of the fumed silica with respect to the total weight of the composition.

Referring to FIG. 8, it may be seen that as a content of the fumed silica increases, the storage modulus of a polymer layer increases. It may be seen that at the same frequency value, the polymer layer according to Example D-6 has a greater storage modulus than the polymer layer according to Example D-1. In addition, it may be seen that in the polymer layers according to Examples D-1 to D-6, a storage modulus at a frequency of about 100 Hz is greater than a storage modulus at a frequency of about 0.1 Hz. It may be confirmed that the polymer layers according to Examples D-1 to D-6 exhibit shear thickening properties. Accordingly, the polymer layers according to embodiments of the present disclosure, which are formed from the compositions further including the fumed silica, may exhibit greater impact resistance.

Meanwhile, in FIG. 5 to FIG. 8, a storage modulus and loss modulus versus a frequency are the results obtained using a frequency sweep test in which 0.1% strain is applied at a temperature of about 25° C. and are measured by the ASTM D4440 method using a rotational rheometer.

FIG. 9A and FIG. 9B show a force over time in protective films according to a comparative examples and embodiments of the present disclosure. FIG. 9A and FIG. 9B show records of a force as measured using a testing device with a piezo sensor (PCB Piezotronics Inc, model name: 200C50) attached thereto, by placing the protective films according to comparative examples and embodiments of the present disclosure on the testing device and dropping a chrome steel ball (diameter of about 10.6 mm and weight of about 4.51 g) from a height of about 30 cm.

FIG. 9A shows a force measured for the protective film according to a comparative example, and the protective film according to the comparative example includes a configuration corresponding the protective film PM-a in FIG. 3B. The protective film according to the comparative example includes three base layers and includes 50 μm-thick layers which are formed of a pressure sensitive adhesive between the first base layer and the second base layer and between the third base layer and the second base layer. For example, the protective film according to the comparative example does not include the polymer layer derived from (e.g., including in whole or in part) the composition.

FIG. 9B illustrates a force measured for the protective film according to embodiments of the present disclosure, and the protective film according to embodiments of the present disclosure includes a configuration corresponding to the protective film PM-a of FIG. 3B. The protective film according to embodiments of the present disclosure includes a first base layer, a polymer layer, a third base layer, an intermediate layer, and a second base layer, and the intermediate layer is formed from the same composition as the polymer layer. The intermediate layer and the polymer layer are formed from a composition which includes about 52.5 g of polyborondimethylsiloxane and about 1 g of benzoyl peroxide. The intermediate layer and the polymer layer each have a thickness of about 50 μm, and the protective film according to embodiments of the present disclosure is a protective film according to an embodiment of the present disclosure. In the protective films according to the comparative example and embodiments of the present disclosure, the first base layer to the third base layer each include polyethylene terephthalate, the first base layer and the third base layer each have a thickness of about 40 μm, and the second base layer has a thickness of about 100 μm.

In FIG. 9A, an area of AA1, formed by connecting L1 and points P1-1 to P1-5, is an amount of impact measured for the protective film according to the comparative example, and in FIG. 9B, an area of AA2, formed by connecting by L2 and points P2-1 to P2-5 is an amount of impact measured for the protective film according to embodiments of the present disclosure. The amount of impact may be obtained by integrating values of forces over time.

Integrating the respective areas in the graphs shown in FIG. 9A and FIG. 8B results in the area of AA1 being about 0.87715 and the area of AA2 being about 0.6727. It may be seen that the area of AA2 is reduced by about 23.3% compared to the area of AA1. The smaller a value of an area, the greater an amount of impact absorbed by the protective film. It is determined that since the amount of impact absorbed by the protective film according to embodiments of the present disclosure is greater than the amount of impact absorbed by the protective film according to the comparative example, the area of the protective film according to embodiments of the present disclosure has a smaller value. Accordingly, the protective film including the polymer layer derived from (e.g., including in whole or in part) the composition according to an embodiment of the present disclosure may contribute to the increase of impact resistance.

FIG. 10A and FIG. 10B are graphs showing a load versus a displacement and showing the results obtained using the butt joint test. The butt joint test was performed according to the ASTM D2095/2094 method. FIG. 10A shows the results measured for protective films according to Comparative Examples E-1 to Comparative Example E-3, and FIG. 10B shows the results measured for protective films according to Example E-1 to Example E-4. The butt joint test was performed at a tensile speed of about 1 mm/min at a temperature of about 25° C.

The protective films, according to embodiments of the present disclosure, were prepared by attaching, to a butt joint bar, a polyethylene terephthalate (PET)-containing first base layer using an adhesive, which is Loctite 401, then providing a polymer layer on the first base layer, providing a PET-containing second base layer on the polymer layer, and then applying a pressure of about 40 kgf/mm² to a stack of three layers that is obtained. Except that in place of the polymer layer, an optically clear adhesive (OCA) is placed on the first base layer, the protective films according to comparative examples were prepared by the same method as the protective films according to embodiments of the present disclosure.

In the protective films according to Comparative Examples E-1 to Comparative Example E-3, an OCA-containing layer is disposed between the two PET-containing base layers. In the protective films according to Comparative Example E-1 to Comparative Example E-3, the OCA is made of OCA 8146-x (3M company). The protective films according to Comparative Examples E-1 to E-3 have the same configuration and material.

In each of the protective films according to embodiments of the present disclosure, a polymer layer derived from (e.g., including in whole or in part) the composition according to an embodiment of the present disclosure is disposed between two PET-containing layers. The composition according to an embodiment of the present disclosure includes about 44.5 g of polyborondimethylsiloxane and about 1.8 g of benzoyl peroxide. The protective films according to comparative examples and embodiments of the present disclosure were prepared by applying a pressure of about 40 kgf/mm² to a stack of three layers. The protective films according to Examples E-1 to E-4 have the same configuration and material.

In FIG. 10A and FIG. 10B, a load is a force applied in a thickness direction of the protective film, and the load is applied to the protective film so that the protective film is pulled in upper and lower directions. A displacement indicates an extending length of the protective film by the load applied to the protective film and is a length extending from upper and lower surfaces of the protective film. In FIG. 10A, the reason why a load applied to a protective film according to Comparative Example E-1 at a displacement of about 0.6 mm or more is not recorded is that the protective film has been peeled off. Also, in FIG. 10B, the reason why a load applied to the protective film according to Example E-1 is not recorded is that the protective film has been peeled off.

Referring to FIG. 10A and FIG. 10B, it may be seen that the protective films according to comparative examples and embodiments of the present disclosure exhibit greater adhesive strength. In the protective films according to Comparative Examples E-1 to E-3, a displacement of a point to which the maximum load is applied is about 0.2 mm, and in the protective films according to Examples E-1 to E-4, a displacement of a point to which the maximum load is applied is about 0.1 mm. Accordingly, it may be seen that the protective films according to Examples E-1 to E-4 have greater peel-off adhesive strength. Therefore, the polymer layer, according to an embodiment of the present disclosure, which is derived from (e.g., including in whole or in part) the composition including polyborondimethylsiloxane and benzoyl peroxide, may exhibit a greater level of adhesive strength.

Table 1 below shows the measurements of the transmittance and haze of each of the protective films according to comparative examples and embodiments of the present disclosure. In Table 1, the protective films according to comparative examples and embodiments of the present disclosure each include five layers, and each of the five layers provided herein has a thickness of about 50 μm.

In Table 1, “P” is a PET-containing layer, “A” is a PSA-containing layer, “S” is a polymer layer derived from (e.g., including in whole or in part) the composition according to an embodiment of the present disclosure, and “F” is a polymer layer derived from (e.g., including in whole or in part) the composition which further includes fumed silica according to an embodiment of the present disclosure. The composition according to an embodiment of the present disclosure includes about 52.2 g of polyborondimethylsiloxane and about 1 g of benzoyl peroxide.

In addition, in Table 1, “T” is a polymer layer formed from a composition which includes the polyborondimethylsiloxane and does not include the benzoyl peroxide. “I” is a polymer layer formed from a composition which includes polyborondimethylsiloxane, does not include benzoyl peroxide, and includes fumed silica.

In a protective film according to Comparative Example 1-1, three layers among five layers each include polyethylene terephthalate, the remaining two layers each include a pressure sensitive adhesive, and the polyethylene terephthalate-containing layers and the pressure sensitive adhesive-containing layers are alternately stacked. A protective film according to Comparative Example 1-2 is formed from a composition which does not include benzoyl peroxide and in which three layers among five layers each include polyethylene terephthalate, and the remaining two layers each include polyborondimethylsiloxane, and polyethylene terephthalate-containing layers and layers formed from the composition that does not include the benzoyl peroxide are alternately stacked. A protective film according to Comparative Example 1-3 is formed from a composition which does not include benzoyl peroxide and includes about 15 wt % of fumed silica with respect to the total weight, and in which three layers among five layers each include polyethylene terephthalate, and the remaining two layers each include polyborondimethylsiloxane, and polyethylene terephthalate-containing layers and layers formed from a composition that includes fumed silica are alternately stacked.

Protective films according to Examples 1-1 to 1-7 each have a configuration corresponding to the protective film PM-a in FIG. 3B. The protective films according to Examples 1-1 to 1-7 each have a first base layer, a polymer layer, a third base layer, an intermediate layer, and a second base layer. In the protective film according to Example 1-1, the intermediate layer and the polymer layer are derived from (e.g., including in whole or in part) the same composition which includes about 52.2 g of the polyborondimethylsiloxane and about 1 g of the benzoyl peroxide. In the protective films according to Examples 1-2 to 1-7, the polymer layer and the intermediate layer each are formed from a composition that further includes fumed silica. In the protective films according to Examples 1-2 to 1-7, the fumed silica is supplied in amounts of about 5 wt %, about 10 wt %, about 15 wt %, about 20 wt %, about 25 wt %, and about 30 wt % respectively with respect to the total weight of the composition when the polymer layer and the intermediate layer are formed.

The transmittance and haze in Table 1 were measured such that the transmittance and haze at a wavelength of about 550 nm were measured using a spectrophotometer (Konica Minolta Inc, model name: CM3700A).

TABLE 1

| Preparation Example of | | | |
|---|---|---|---|
| protective film | | Transmittance (%) | Haze (%) |
| Comparative | PAPAP | 89.5 | 2.0 |
| Example 1-1 | | | |
| Comparative | PTPTP | 91.8 | 3.9 |
| Example 1-2 | | | |
| Comparative | PIPIP, 15 wt % | 89.1 | 6.1 |
| Example 1-3 | | | |
| Example 1-1 | PSPSP | 90.0 | 4.5 |
| Example 1-2 | PFPFP, 5 wt % | 89.5 | 4.7 |
| Example 1-3 | PFPFP, 10 wt % | 90.0 | 4.8 |
| Example 1-4 | PFPFP, 15 wt % | 89.4 | 5.3 |
| Example 1-5 | PFPFP, 20 wt % | 89.1 | 6.6 |
| Example 1-6 | PFPFP, 25 wt % | 90.0 | 8.4 |
| Example 1-7 | PFPFP, 30 wt % | 88.8 | 8.7 |

Referring to Table 1, it may be seen that through comparison, the protective films according to Examples 1-1 to 1-7 exhibit a transmittance as similar to that of the protective film according to Comparative Example 1-1, which includes a pressure sensitive adhesive (PSA). It may be seen that the protective films according to Examples 1-1 to 1-7 each have a haze of about 4.5% to about 8.7%. In addition, it may be seen that compared to the protective film according to Comparative Example 1-2, the protective film according to Example 1-1 has a greater level of transmittance. The protective film according to Comparative Example 1-2 and the protective film according to Example 1-1 differ from each other only with respect to whether, in a layer disposed between polyethylene terephthalate-containing layers and formed from a composition, the composition contains benzoyl peroxide or not.

In Table 1, it may be seen that the protective films according to Examples 1-1 to 1-7 each have a transmittance of about 88% or more in a wavelength range of about 400 nm to about 800 nm. It may be seen that the protective films according to Examples 1-1 to 1-7 each have a haze of about 0.1% to about 10%. Accordingly, a display device including the protective film according to an embodiment of the present disclosure may exhibit greater optical transparency.

Table 2 below shows the measurements of impact force measured by placing protective films according to comparative examples and embodiments of the present disclosure on a testing device with a piezoelectric sensor (PCB Piezotronics Inc, model name: 500C50) attached thereto and dropping a chrome steel ball (diameter of about 10.6 mm and weight of about 4.51 g) from a height of about 30 cm. The protective films according to comparative examples and embodiments of the present disclosure each have five layers each having a thickness of about 50 μm. The impact forces shown in Table 2 are average values of impact forces measured three times.

In Table 2, “P” is a PET-containing layer, “A” is a PSA-containing layer, “S” is a polymer layer derived from (e.g., including in whole or in part) a composition according to an embodiment of the present disclosure, and “D” is a layer including a product of DOWSIL™ 3179. The composition according to an embodiment of the present disclosure includes about 52.2 g of polyborondimethylsiloxane and about 1 g of benzoyl peroxide. The protective film according to Comparative Example 2-1 is the same as the protective film according to Comparative Example 1-1, and the protective film according to Example 2 is the same as the protective film according to Example 1-1.

In Table 2, “Floor” is the measurement of impact force measured by dropping a chrome steel ball (diameter of about 10.6 mm and weight of about 4.51 g), from a height of about 30 cm in a state in which protective films according to comparative examples and embodiments of the present disclosure are not placed on a testing device with a piezoelectric sensor (PCB Piezotronics Inc, model name: 500C50) attached thereto.

TABLE 2

| Preparation Example of protective film | | Impact force (N) |
|---|---|---|
| Floor | | 289.3 |
| Comparative Example 2- | PPPPP | 229.6 |
| 1 | | |
| Comparative Example 2- | PSPDP | 190.6 |
| 2 | | |
| Comparative Example 2- | PDPSP | 194.5 |
| 3 | | |
| Comparative Example 2- | PAPAP | 178.9 |
| 4 | | |
| Comparative Example 2- | PDPDP | 218.1 |
| 5 | | |
| Example 2 | PSPSP | 163.4 |

Referring to Table 2, it may be seen that the protective films according to Comparative Examples 2-1 to 2-5 and Example 2 have a satisfactory level of impact force. As the protective films according to Comparative Examples 2-1 to 2-5 and Example 2 absorb impact, impact forces measured for the protective films according to Comparative Examples 2-1 to 2-5 and Example 2 are reduced compared to an impact force measured in the state of Floor. It may be seen that the protective film according to Example 2 has greater impact resistance compared to the protective films according to Comparative Examples 2-1 to 2-5. Accordingly, a display device including the protective film which includes the polymer layer according to an embodiment of the present disclosure may exhibit increased impact resistance. Table 3 below shows the measurements of impact forces measured by placing the protective films according to comparative examples and embodiments of the present disclosure on a testing device with a piezo sensor (PCB Piezotronics Inc, model name: 200C50) attached thereto and dropping a chrome steel ball (diameter of about 10.6 mm and weight of about 4.51 g) from a height of about 30 cm. The protective films according to comparative examples and embodiments of the present disclosure each have five layers each having a thickness of about 50 μm. The impact forces shown in Table 3 are average values of impact forces measured three times.

In Table 3, “P” is a PET-containing layer, “A” is a PSA-containing layer, “S” is a polymer layer derived from (e.g., including in whole or in part) a composition according to an embodiment of the present disclosure, and “F” is a polymer layer derived from (e.g., including in whole or in part) a composition which further includes the fumed silica according to an embodiment of the present disclosure. The composition according to an embodiment of the present disclosure includes about 52.2 g of polyborondimethylsiloxane and about 1 g of benzoyl peroxide.

Protective films according to Comparative Examples 3-1 and 3-2 are the same as the protective films according to Comparative Examples 1-1 and 1-2. The protective films according to Examples 3-1 to 3-6 are the same as the protective films according to Examples 1-1 to 1-6. In Table 3, “Floor” is the measurement of impact force measured by dropping a chrome steel ball (diameter of about 10.6 mm and weight of about 4.51 g) from a height of about 30 cm in a state in which the protective films according to comparative examples and embodiments of the present disclosure are not placed on a testing device with a piezoelectric sensor (PCB Piezotronics Inc, model name 500C50) attached thereto.

TABLE 3

| Preparation Example of protective film | | Impact force (N) |
|---|---|---|
| Floor | | 178.7 |
| Comparative Example 3-1 | PPPPP | 149.5 |
| Comparative Example 3-2 | PAPAP | 121.2 |
| Example 3-1 | PSPSP | 92.8 |
| Example 3-2 | PFPFP, 5 wt % | 75.7 |
| Example 3-3 | PFPFP, 10 wt % | 79.5 |
| Example 3-4 | PFPFP, 15 wt % | 70 |
| Example 3-5 | PFPFP, 20 wt % | 65.4 |
| Example 3-6 | PFPFP, 25 wt % | 49.9 |

Referring to Table 3, it may be seen that the protective films according to Comparative Example 3-2 and Examples 3-1 to 3-6 have greater impact resistance. It may be seen that the protective films according to Examples 3-1 to 3-6 have increased impact resistance compared to the protective films according to Comparative Examples 3-1 and 3-2. The protective films according to Examples 3-1 to 3-4 include a polymer layer derived from (e.g., including in whole or in part) a composition including polyborondimethylsiloxane and benzoyl peroxide, thereby exhibiting increased impact resistance. It may be seen that the fumed silica-containing protective films according to Examples 3-2 to 3-6 have greater impact resistance. It is determined that the protective films according to Examples 3-2 to 3-6 each include fumed silica, thereby having increased impact resistance. It may be seen that the impact resistance of the protective film according to Example 3-6, which includes about 25 wt % of the fumed silica, is reduced by about 67% compared to the protective film according to Comparative Example 3-1, which does not include the fumed silica. Accordingly, the protective film including the polymer layer derived from (e.g., including in whole or in part) the composition which further includes fumed silica may exhibit greater impact resistance.

Table 4 shows the measurements of light transmittance at a wavelength of about 550 nm for protective films according to comparative examples and embodiments of the present disclosure, using a UV spectrophotometer. In Table 4, “P1” is a PET-containing layer having a thickness of about 100 μm, and “P2” and “P3” each are a PET-containing layer having a thickness of about 40 μm. “A” is a PSA-containing layer and “S” is a polymer layer derived from (e.g., including in whole or in part) a composition according to an embodiment of the present disclosure. The composition according to an embodiment of the present disclosure includes about 52.2 g of polyborondimethylsiloxane and about 1 g of benzoyl peroxide.

A protective film according to Example 4-1 includes three layers in which a PET-containing layer having a thickness of about 40 μm, a polymer layer derived from (e.g., including in whole or in part) the composition according to an embodiment of the present disclosure, and a PET-containing layer having a thickness of about 100 μm are sequentially stacked. The protective film according to Comparative Example 4-1 includes the same configuration as the protective film according to Example 4-1 except that the former uses the PSA-containing layer in place of a polymer layer.

TABLE 4

| Preparation Example of protective film | | Transmittance (%) |
|---|---|---|
| Comparative Example 4-1 | P2/A/P1 | 90.9 |
| Example 4-1 | P2/S/P1 | 89.3 |
| Comparative Example 4-2 | P3/A/P2 | 86.7 |
| Example 4-2 | P3/S/P2 | 88.1 |

Referring to Table 4, it may be seen that the protective films according to embodiments of the present disclosure, each of which includes the polymer layer derived from (e.g., including in whole or in part) the composition of an embodiment of the present disclosure, exhibit a greater level of transmittance. It is determined that the polymer layer derived from (e.g., including in whole or in part) the composition according to an embodiment of the present disclosure has a greater level of optical transmittance. Accordingly, a display device including the protective film which includes the polymer layer according to an embodiment of the present disclosure may maintain the reliability of the display quality. Table 5 below shows the measurements of impact force measured by placing protective films according to comparative examples and embodiments of the present disclosure on a testing device with a piezo sensor (PCB Piezotronics Inc, model name: 200C50) attached thereto and dropping a chrome steel ball (a diameter of about 10.6 mm and a weight of about 4.51 g) from a height of about 30 cm. The impact forces shown in Table 5 are average values of impact forces measured three times for the protective films according to comparative examples and embodiments of the present disclosure.

In Table 5, “P1” is a PET-containing layer having a thickness of about 100 μm, and “P2” and “P3” each are a PET-containing layer having a thickness of about 40 μm. “A” is a PSA-containing layer and “S” is a polymer layer derived from (e.g., including in whole or in part) the composition according to an embodiment of the present disclosure. The composition according to an embodiment of the present disclosure includes about 52.2 g of polyborondimethylsiloxane and about 1 g of benzoyl peroxide. In Table 5, “Floor” is the measurement of impact force measured by dropping a chrome steel ball (diameter of about 10.6 mm and weight of about 4.51 g) from a height of about 30 cm in a state in which the protective films according to comparative examples and embodiments of the present disclosure are not placed on a testing device with a piezo sensor (PCB Piezotronics Inc, model name: 200C50) attached thereto.

TABLE 5

| Preparation Example of protective film | | Impact force (N) |
|---|---|---|
| Floor | | 258.2 |
| Comparative Example 5-1 | P3/A/P2/A/P1 | 200 |
| Example 5-1 | P3/S/P2/S/P1 | 171 |
| Comparative Example 5-2 | P2/A/P1 | 208.1 |
| Example 5-2 | P2/S/P1 | 182.7 |

Referring to Table 5, it may be seen that the protective films according to comparative examples and embodiments of the present disclosure have increased impact resistance. The protective films according to Examples 5-1 and 5-2 have increased impact resistance compared to the protective films according to Comparative Examples 5-1 and 5-2. It is determined that the protective films according to Examples 5-1 and 5-2 each include a polymer layer derived from (e.g., including in whole or in part) the composition including polyborondimethylsiloxane and benzoyl peroxide, thereby exhibiting increased impact resistance. Accordingly, a display device including the protective film including the polymer layer according to an embodiment of the present disclosure may exhibit greater impact resistance.

Table 6 shows the evaluation of “pen drop” for display devices according to a comparative example and embodiments of the present disclosure. Table 6 shows the measurements of height at which the display devices according to the comparative example and embodiments of the present disclosure become defective when the same pen is dropped onto the display devices. The display devices according to Comparative Example 6 and Examples 6-1 to 6-5 each include a display panel and a protective film according to the comparative example or embodiments of the present disclosure, which is disposed on the display panel. The display panel and the protective film are bonded to each other with a pressure sensitive adhesive.

In Table 6, “P1” is a PET-containing layer having a thickness of about 100 μm and “P2” and “P3” each are a PET-containing layer having a thickness of about 40 μm. “A” is a PSA-containing layer having a thickness of 50 μm and “S” is a 50 μm-thick polymer layer derived from (e.g., including in whole or in part) the composition of an embodiment of the present disclosure. “F” is a 50 μm-thick polymer layer derived from (e.g., including in whole or in part) the composition which further includes fumed silica according to an embodiment of the present disclosure. The composition according to an embodiment of the present disclosure includes about 52.2 g of polyborondimethylsiloxane and about 1 g of benzoyl peroxide.

In a protective film according to Example 6-4, two polymer layers each are derived from (e.g., including in whole or in part) a composition which includes fumed silica in an amount of about 10 wt % with respect to the total weight of the composition. In a protective film according to Example 6-5, two polymer layers each are derived from (e.g., including in whole or in part) a composition which includes fumed silica in an amount of about 15 wt % with respect to the total weight of the composition.

TABLE 6

| Preparation Example of protective film | | Pen drop (cm) |
|---|---|---|
| Comparative Example 6 | P3/A/P2/A/P1 | 6 |
| Example 6-1 | P3/S/P2/S/P1 | 9 |
| Example 6-2 | P3/S/P2/A/P1 | 8 |
| Example 6-3 | P3/A/P2/S/P1 | 8 |
| Example 6-4 | P3/F/P2/F/P1, 10 wt % | 8 |
| Example 6-5 | P3/F/P2/F/P1, 15 wt % | 10 |

Referring to Table 6, it may be seen that compared to the protective film according to Comparative Example 5, the protective films according to Examples 6-1 to 6-5 exhibit increased impact resistance. The protective films according to Examples 6-1 to 6-5 each include at least one polymer layer, which is derived from (e.g., including in whole or in part) the composition according to an embodiment of the present disclosure. Accordingly, a display device including the polymer layer according to an embodiment of the present disclosure may exhibit increased impact resistance.

In Table 7, “P1” is a PET-containing layer having a thickness of about 100 μm and “P2” and “P3” each are a PET-containing layer having a thickness of about 40 μm. “A” is a PSA-containing layer having a thickness of about 50 μm and “S” is a 50 μm-thick polymer layer derived from (e.g., including in whole or in part) the composition according to an embodiment of the present disclosure. “F” is a 50 μm-thick polymer layer derived from (e.g., including in whole or in part) the composition which further includes fumed silica according to an embodiment of the present disclosure. In Table 7, the composition according to an embodiment of the present disclosure includes about 52.2 g of polyborondimethylsiloxane and about 1 g of benzoyl peroxide.

In addition, in Table 7, “T” is a 50 μm-thick polymer layer formed from a composition which includes polyborondimethylsiloxane and does not include benzoyl peroxide. “I” is a 50 μm-thick polymer layer formed from a composition which includes polyborondimethylsiloxane, does not include benzoyl peroxide, and includes fumed silica.

In the protective film according to Example 7-1, a polymer layer and an intermediate layer are derived from (e.g., including in whole or in part) the same composition. In each of protective films according to Examples 7-2 to 7-7, a polymer layer and an intermediate layer are formed from the composition which further includes fumed silica. In the protective films according to Examples 7-2 to 7-7, fumed silica is supplied in amounts of about 5 wt %, about 10 wt %, about 15 wt %, about 20 wt %, about 25 wt %, and about 30 wt % respectively with respect to the total weight of the composition when the polymer layer and the intermediate layer are formed. The transmittances and haze shown in Table 7 were measured such that the transmittance and haze at a wavelength of about 550 nm were measured using a spectrophotometer (Konica Minolta Inc, model name: CM3700A).

TABLE 7

| Preparation | | Transmittance | Haze value |
|---|---|---|---|
| Example of protective film | | (%) | (%) |
| Comparative | P3/A/P2/A/P1 | 89.3 | 0.8 |
| Example 7-1 | | | |
| Comparative | P3/T/P2/T/P1 | 90.4 | 3.5 |
| Example 7-2 | | | |
| Comparative | P3/1/P2/1/P1, 15 wt % | 90.8 | 5.1 |
| Example 7- 3 | | | |
| Example 7-1 | P3/S/P2/S/P1 | 91.9 | 2.0 |
| Example 7-2 | P3/F/P2/F/P1, 5 wt % | 90.2 | 4.9 |
| Example 7-3 | P3/F/P2/F/P1, 10 wt % | 89.8 | 4.9 |
| Example 7-4 | P3/F/P2/F/P1, 15 wt % | 90.0 | 5.0 |
| Example 7-5 | P3/F/P2/F/P1, 20 wt % | 89.5 | 5.6 |
| Example 7-6 | P3/F/P2/F/P1, 25 wt % | 89.8 | 5.8 |
| Example 7-7 | P3/F/P2/F/P1, 30 wt % | 89.5 | 8.0 |

Referring to Table 7, it may be seen that compared to the protective film according to Comparative Example 7-1, the protective films according to Examples 7-1 to 7-7 have greater impact resistance. It may be seen that the protective films according to Examples 7-1 to 7-7 each have a haze of about 2.0% to about 8.0%. In addition, it may be seen that the protective film according to Example 7-1 has greater transmittance compared to the protective film according to Comparative Example 7-2. The protective film according to Comparative Example 7-2 and the protective film according to Example 7-1 have different compositions provided at the time of forming the polymer layer and differ from each other only with respect to whether the composition contains benzoyl peroxide or not. It may be seen that the protective films according to Examples 7-2 to 7-5, each of which includes the polymer layer derived from (e.g., including in whole or in part) the composition which includes fumed silica, have a greater level of transmittance.

In Table 7, it may be seen that the protective films according to Examples 7-1 to 7-7 each have a transmittance of about 89% or more in a wavelength range of about 400 nm to about 800 nm. It may be seen that the protective films according to Examples 7-1 to 7-7 each have a haze of about 0.1% to about 10%. Therefore, a display device including the protective film according to an embodiment of the present disclosure may exhibit greater optical transparency.

A polymer layer, according to an embodiment of the present disclosure, is formed from a composition including polyborondimethylsiloxane and benzoyl peroxide and has a transmittance of about 84% or more in a wavelength range of about 400 nm to about 800 nm. The polymer layer formed from the composition including polyborondimethylsiloxane and benzoyl peroxide may have greater optical transparency and exhibit shear thickening properties so that a storage modulus increases when external force is applied. Accordingly, the polymer layer, according to an embodiment of the present disclosure, may contribute to the increase of impact resistance and the maintenance of the reliability.

A display device of an embodiment of the present disclosure may include a display panel and a protective film disposed on the display panel. The protective film may include a polymer layer and the polymer layer may be formed from a composition including polyborondimethylsiloxane and benzoyl peroxide. Since the polymer layer has greater optical transparency and shear thickening properties, the display device, according to an embodiment of the present disclosure, which includes the polymer layer, may exhibit increased impact resistance while maintaining the reliability of the display quality.

A polymer layer according to an embodiment of the present disclosure is derived from (e.g., including in whole or in part) a composition including polyborondimethylsiloxane and benzoyl peroxide, thereby exhibiting increased impact resistance and greater optical transparency.

A display device, according to an embodiment of the present disclosure, includes a polymer layer, according to an embodiment of the present disclosure, thereby exhibiting greater optical transparency and impact resistance.

In the foregoing description, although embodiments of the inventive concept have been described and illustrated, it would be understood that various changes and modifications can be made to the inventive concept by one ordinary skilled in the art within the spirit and scope of the present disclosure.

Accordingly, the technical scope of the inventive concept should not necessarily be limited to the content described in the detailed description of the specification.

What is claimed is:

1. A polymer layer derived from a composition comprising:
polyborondimethylsiloxane; and
benzoyl peroxide,
wherein the polymer layer has a light transmittance of about 84% or more in a wavelength range of about 400 nm to about 800 nm.

2. The polymer layer of claim 1, wherein the polymer layer has shear thickening properties such that a storage modulus increases when external force is applied.

3. The polymer layer of claim 1, wherein the polyborondimethylsiloxane includes a repeating unit represented by Formula 1 below: 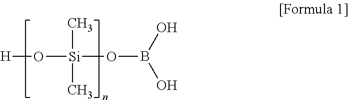
wherein in Formula 1, n is a positive integer.

4. The polymer layer of claim 1, wherein, in the composition, a mass ratio of the polyborondimethylsiloxane the benzoyl peroxide is about 8:1 to about 53:1.

5. The polymer layer of claim 1, wherein the polyborondimethylsiloxane is formed through a condensation polymerization reaction between polydimethylsiloxane and boric acid, and
wherein a mass ratio of the polydimethylsiloxane to the boric acid is about 25:1 to about 500:1.

6. The polymer layer of claim 1, wherein the polymer layer is formed by performing a reaction on the composition for about one hour to about eight hours under a condition in which heat and/or light is supplied.

7. The polymer layer of claim 1, wherein the composition further comprises fumed silica.

8. The polymer layer of claim 7, wherein with respect to a total weight of the composition, the fumed silica is included in an amount of about 30 wt % or less.

9. The polymer layer of claim 1, wherein the composition further comprises glass fiber, glass powder, carbon nanotube, graphene oxide, carbonyl iron, CaCO₃, CaO, and/or ZnO.

10. The polymer layer of claim 1, wherein the composition further comprises silicone elastomer, polydimethylsiloxane (PDMS), polymethyl methacrylate (PMMA), and/or an acrylic resin.

11. The polymer layer of claim 1, wherein the polymer layer has a gel point at which a storage modulus is the same as a loss modulus at a first frequency of about 0.1 Hz to about 100 Hz.

12. The polymer layer of claim 11, wherein the loss modulus is greater than the storage modulus at a frequency less than the first frequency corresponding to the gel point, and the storage modulus is greater than the loss modulus at a frequency greater than the first frequency, and the storage modulus and the loss modulus each are measured according to a ASTM D4440 method.

13. The polymer layer of claim 12, wherein the storage modulus increases as a frequency increases.

14. A display device, comprising:
a display panel; and
a protective film disposed on the display panel, the protective film including a first base layer, a second base layer disposed on the first base layer, and a polymer layer disposed between the first base layer and the second base layer,
wherein the polymer layer is derived from a composition including polyborondimethylsiloxane and benzoyl peroxide and the polymer layer has a light transmittance of about 84% or more in a wavelength range of about 400 nm to about 800 nm.

15. The display device of claim 14, wherein the protective film further comprises:
a third base layer disposed between the first base layer and the second base layer; and
an intermediate layer disposed between the first base layer and the third base layer or between the second base layer and the third base layer,
wherein the intermediate layer includes a polymer derived from the composition or a pressure sensitive adhesive.

16. The display device of claim 14, wherein the protective film further comprises:
a first sub intermediate layer disposed between the polymer layer and the second base layer; and
a second sub intermediate layer disposed between the first sub intermediate layer and the second base layer or between the first base layer and the polymer layer,
wherein each of the first sub intermediate layer and the second sub intermediate layer including a polymer including the composition or a pressure sensitive adhesive.

17. The display device of claim 14, further comprising:
a window disposed between the display panel and the protective film; and
a window polymer layer disposed between the display panel and the window,
wherein the window polymer layer is derived from the composition.

18. The display device of claim 14, wherein a polymer derived from the composition has shear thickening properties such that a storage modulus increases when external force is applied.

19. The display device of claim 14, wherein the composition further comprises fumed silica, and with respect to a total weight of the composition, the fumed silica is included in an amount of about 30 wt % or less.

20. The display device of claim 14, wherein the composition further comprises glass fiber, glass powder, carbon nanotube, graphene oxide, carbonyl iron, CaCO₃, CaO, and/or ZnO.

21. The display device of claim 14, wherein the composition further comprises silicone elastomer, polydimethylsiloxane (PDMS), polymethyl methacrylate (PMMA), and/or an acrylic resin.

22. The display device of claim 14, wherein the polymer layer has a first storage modulus in a first state, and has a second storage modulus in a second state after external force is applied thereto, and
wherein the second storage modulus is about 10 times to about 12,000 times greater than the first storage modulus.

23. The display device of claim 14, wherein the polymer layer has a haze value of about 0.1% to about 10%.

24. The display device of claim 14, wherein the polymer layer has a thickness of about 10 μm to about 1000 μm.

25. The display device of claim 14, wherein a second thickness of the second base layer is greater than a first thickness of the first base layer.

26. The display device of claim 14, wherein each of the first base layer and the second base layer includes polyethylene terephthalate (PET), polybutylene terephthalate (PBT), polyethylene naphthalate (PEN), polycarbonate (PC), polymethyl methacrylate (PMMA), polyethersulfone (PES), polyamide (PA), modified-polyphenylene oxide (m-PPO), polyoxymethylene (POM), polyamide-imide (PAI), polyether block amide (PEBA), and/or polyarylate, (PAR).

27. The display device of claim 14, wherein the display panel is configured to be folded about at least one folding axis.
